(19) United States
(12) Patent Application Publication
(10) Pub. No.: US 2002/0031097 A1
(43) Pub. Date: Mar. 14, 2002

(54) Real time webcasting system and method for multicasting various multimedia contents through multichannel

(75) Inventor: Yeon Tae Jung, Douglaston, NY (US)

Correspondence Address: STAAS & HALSEY LLP, 700 11TH STREET, NW, SUITE 500, WASHINGTON, DC, 20001, US

(73) Assignee: KoreaMultlnetInc., Seoul (KR)

(21) Appl. No.: 09/880,059

(22) Filed: Jun. 14, 2001

(30) Foreign Application Priority Data
Jun. 17, 2000 (KR) 2000-33487

(51) Int. Cl. H04L 12/16

(52) U.S. Cl. 370/270; 370/343; 370/401; 370/487; 709/249

(57) ABSTRACT

A webcasting system for multicasting various multimedia contents through plurality of channels in real time by employing a ground-way technology includes a plurality of broadcasting stations for providing multimedia services, a combiner connected to the broadcasting stations for combining the multimedia services, a web server 300 connected to the combiner and a public network for communicating with the combiner and receiving subscription for the multimedia services, at least one local multicasting station connected to the combiner for receiving combined data stream from the combiner, a plurality of user terminals connected to the web server via public network.

### BACKGROUND OF THE INVENTION

(a) Field of the Invention

The present invention relates to an Internet data transmission and, more particularly, to a webcasting system and method for multicasting various multimedia such as digital video through a plurality of channels in real time by employing a ground-wave, wherein the plurality of channels includes at least one dedicated channel for webcasting and a channel for data communication.

(b) Description of the Related Art

Generally, conventional Internet data transmission consists of a unicast, broadcast, and multicast. In the unicast transmission, data is transmitted on a one to one basis using a recipient's Internet protocol (IP) address contained in an IP header of an IP packet. This unicast transmission is generally employed in TCP/IP-based network applications such as Telnet, FTP, and etc. In case of broadcast data is transmitted by one sender to all recipients using a subnet address such that all the users in the subnet receive the broadcasted packet regardless of the recipients'willingness. Accordingly, the broadcast transmission causes large network traffics. While, in the multicast transmission, data can be simultaneously transmitted to one or more recipients by one or more senders using a group address which is a virtual group ID but not a host or subnet address. In this type of transmission, intelligent routers can recognize virtual group ID so as to copy the original data packet and send the recipients belongs to the virtual group.

The unicast transmission causes network traffics as the local loop network users increase between the users and the internet service providers (ISP), resulting in bottleneck.

Even though the routers at the ISP premises are able to support multicast transmission, it is impossible to multicast contents through multichannels due to the bottleneck problem.

Also, in the unicast transmission, the packet is copied as much as the number of the recipients that request the same data so as to waste network resources, resulting in degradation of the reliability of the stable data transmission multimedia quality.

Furthermore, since the quality of the webcasting service depends on the bandwidth assigned to each subscriber, the channel bandwidth assigned to each subscriber is getting narrow if the whole subscribers increases, resulting in bad quality of multimedia service.

### SUMMARY OF THE INVENTION

The present invention has been made in an effort to solve the above problems of the prior art.

The present invention has been made in an effort to solve the above problems of the prior art.

It is an object of the present invention to provide a webcasting system and method for multicasting various multimedia contents such as digital video through a plurality of channels in real time by employing a ground wave in local loop.

It is another object of the present invention to provide a webcasting system and method capable of multicasting high quality video and audio contents in reliable speed regardless with increase of subscribers.

It is still another object of the present invention to provide a storage medium storing command sets for executing program applications to perform a webcasting method for multicasting various multimedia contents such as digital video through a plurality of channels in real time by employing a ground wave in local loop.

To achieve the above objects, the webcasting system for multicasting various multimedia contents through plurality of channels in real time by employing a ground-way technology comprises a plurality of broadcasting stations for providing multimedia services, a combiner connected to the broadcasting stations for combining the multimedia services, a web server 300 connected to the combiner and a public network for communicating with the combiner and receiving subscription for the multimedia services, at least one local multicasting station connected to the combiner for receiving combined data stream from the combiner, a plurality of user terminals connected to the web server via public network.

Also, the webcasting method for multicasting various multimedia contents of the present invention comprises the steps of subscribing for multimedia services on a web site in a web server connected to a public network, registering a subscriber as a member by storing a subscriber IP and other subscriber's information, requesting channel establishment to the web server by the subscriber sending a channel establishment request signal, verifying the subscriber by looking up a table listing the subscriber IPs, and establishing a channel if the subscriber IP is valid.

### BRIEF DESCRIPTION OF THE DRAWINGS

The accompanying drawings, which are incorporated in and constitute a part of the specification, illustrate an embodiment of the invention, and together with the description, serve to explain the principles of the invention.

FIG. 1 is a block diagram illustrating a webcasting system for multicasting various multimedia contents such as digital video through a plurality of channels in real time by employing a ground-wave technology in accordance with a preferred embodiment of the present invention;

FIG. 2 is a block diagram illustrating a modem of the webcasting system of FIG. 1;

FIG. 3 a flowchart illustrating a webcasting method according to the preferred embodiment of the present invention.

### DETAILED DESCRIPTION OF THE PREFERRED EMBODIMENTS

A preferred embodiment of the present invention will be described with reference to accompanying drawings.

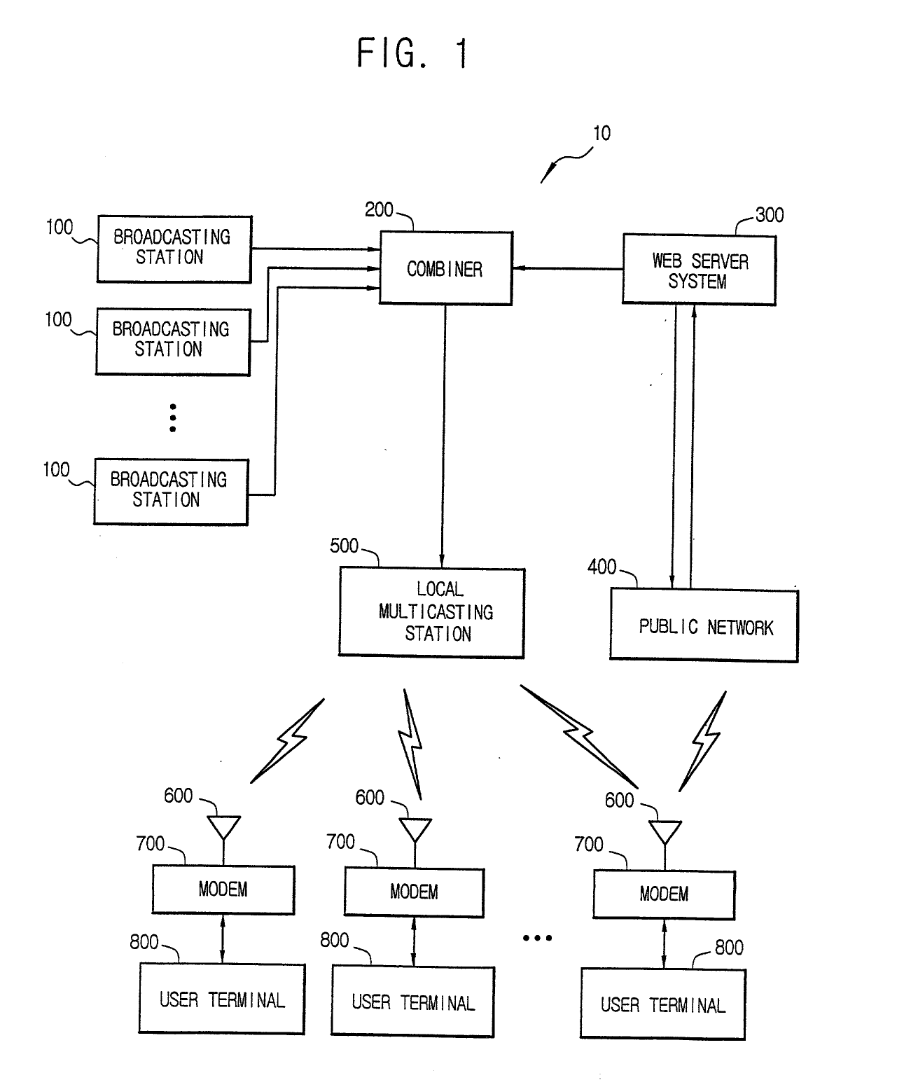

FIG. 1 is a block diagram illustrating a webcasting system for multicasting various multimedia contents such as digital video through a plurality of channels in real time by employing a ground wave technology in accordance with a preferred embodiment of the present invention. The plurality of channels includes at least one downward web casting channel and a data communication channel.

As shown in FIG. 1, a webcasting system 10 comprises a plurality of broadcasting stations 100 for providing respective multimedia contents, a combiner 200 connected to the broadcasting stations 100 through dedicated lines, a web server 300 connected to the combiner 200 through dedicated line and to a public network 400 such as Internet, at least one local multicasting station 500 connected to the combiner 200 through duplex dedicated line, a plurality of user terminals 800 that are connected to the web server 300 through the public network 400 and the local multicasting station 500 through wireless channel. Each user terminal 800 is provided with a modem 700 having an antenna 600 so as to receive webcasting signals from the local multicasting station 500.

Each broadcasting station 100 produces multimedia contents formatted in motion picture expert group 2 (MPEG-2) or MPEG-4 standard and transmits the data to the combiner 200. The broadcasting station 100 can be one of various conventional broadcasting devices and multimedia stream servers. The combiner 200 receives and combines various multimedia data from the broadcasting stations 100 and transmits in combined data stream to the local multicasting station 500.

The local multicasting station 500 splits the data stream from the combiner 200 into the number of original multimedia data according to the broadcasting stations 100 and carries the multimedia data on previously assigned microwave channels in a predetermined bandwidth, which is divided into the number of channels as many as the broadcasting stations. The local multicasting station 500 can be an intelligent wireless router having a multicasting function and broadcasting satellite wirelessly communicating with the combiner 200.

Accordingly, the local multicasting station 500 continuously multicasts all the multimedia contents from the broadcasting stations through multichannels at the same time such that all channels are exposed to the user terminals 800.

At least one of the channels in the predetermined frequency band is a duplex data channel such that the web server 300 and the user terminal 800 can make interactive communications.

Each user terminal 800 is provided with a modem 700 installed therein or connected through a cable such as coaxial, shielded twisted pair (STP) and unshielded twisted pair (UTP) thereto. Also, the user terminal 700 can be a personal computer (PC), notebook computer, or personal digital assistant (PDA).

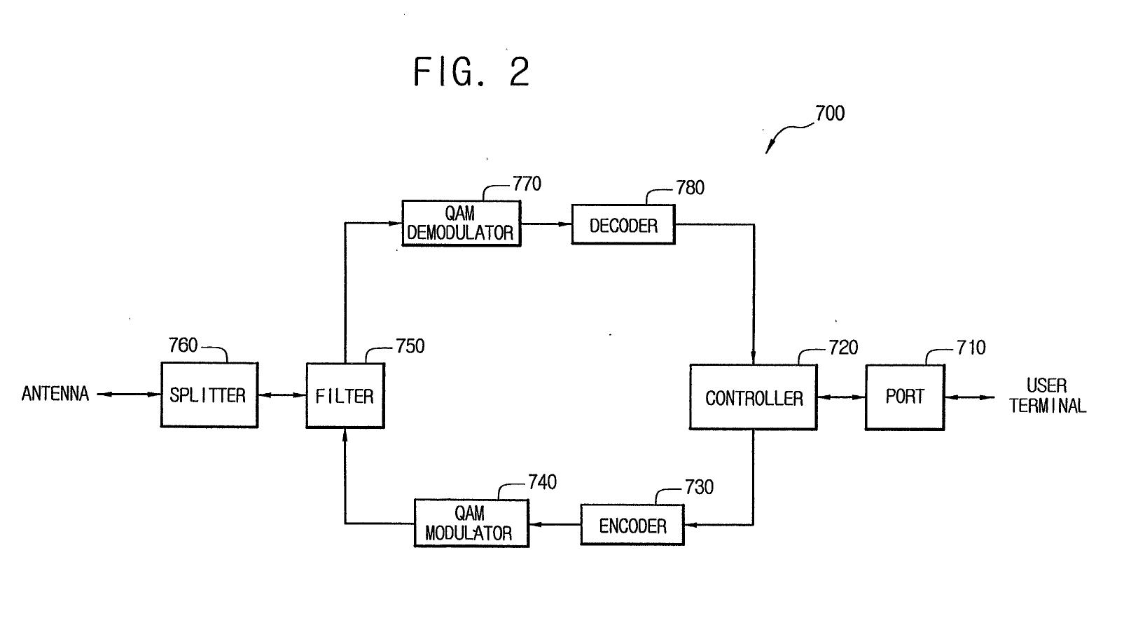

FIG. 2 is a block diagram illustrating the modem of the webcasting system of the present invention.

As shown in FIG. 2, the modem 700 comprises an antenna 600 for receiving the data signals from the local multicasting station 500 through the air, a splitter 760 connected to the antenna 600 for splitting the data signals according to the frequency channels, a filter 750 connected to the splitter 760 for filtering a controlling signal and data signal, a quadrature amplitude multiplexing (QAM) demodulator 770 connected to the filter 750 for demodulating the controlling signal and data signal, a decoder 780 connected to the QAM demodulator 770 for decoding the controlling and data signal, a controller 720 connected to the decoder 780 for detecting the user IP and channel establishment or release signal so as to establish or release webcasting, an encoder 730 connected to the controller 720 for encoding digital signal from the user terminal 800, and a QAM modulator connected to the encoder 730 for modulating the encoded digital signal from the encoder 730 and sending the modulated signal to the filter 750 so as to transmit the signal to the web server 300. The modem 700 communicates with the user terminal 800 through the port 710.

Also, the modem 700 is provided with a physical backup line (not shown) so as to maintain channel connection through the public network 400 even when the wireless connection is broken and the antenna 600 is a two-way antenna so as to receives incoming signals and transmits outgoing signals.

The operation of the above structured webcasting system will be described hereinafter.

Firstly, the user terminal 800 accesses the web site in the web server 300 and subscribe to a webcasting channel such that the web server 300 register the subscriber as a member and storing the subscriber's information and IP address.

After the subscription, the user terminal requests a channel establishment to the web server 300 through one of the wireless channels or the backup line such as a PSTN or dedicated line.

If the web server 300 receives the channel establishment request, the web server 300 determines whether the request is valid or not by verifying the IP address.

If the request is valid, the web server 300 sends a channel open signal and a subscriber's ID to the combiner 200 and then the combiner 200 inserts the channel open signal and the subscriber's ID into a data field of the packet such that the local multicasting station 500 multicasts the multimedia data from the broadcasting stations 100 on the basis of the subscriber's ID.

The multimedia data carried on the corresponding frequency channels are propagated so as to be exposed to all the user terminal 800 having the antenna 600 such that the modem 700 receives the all signals from the antenna 600 and filters signals having the user terminal IP and sends the user terminal 800. Accordingly, each user terminal 800 can selectively receive multimedia contents it requests.

A channel release operation is performed in the same manner of the channel establishment operation except for the channel release request signal is used.

The web casting system of the present invention uses the Multipoint Multichannel Distribution System (MMDS), also called wireless cable, between the local multicasting station 500 and the user terminal 800. The package of the broadcasting station programs is transmitted on a very high frequency (2.535˜2.655 Ghz). On these frequencies the broadcasting stations 100 are combined to the local multicasting station 500.

The MMDS provides 33 6 Mhz channels and one 6 Mhz channel provides 27 Mbps of bandwidth if modulated by 64 QAM. Accordingly, 27 webcasting channels can be provided if each broadcasting station 100 is assigned by as much as 1 Mbps such that the webcasting system of the present invention can provide the subscribers with 27 high quality multimedia service channels per 6 Mhz bandwidth in real time. A predetermined number of channels among the 33 6 Mhz channels are assigned for downward multicasting and the remained channels for two-way data communication such as telephony, video conference, and internet access on the basis of the TCP/IP.

As the local loop technology of the webcasting system of the present invention, the MMDS can be replaced by Local Channel Multipoint Distribution Service (LMDS), Broadband Wireless Local Loop (BWLL), Broadband Multimedia Wireless System (BMWS), satellite communication, and etc.

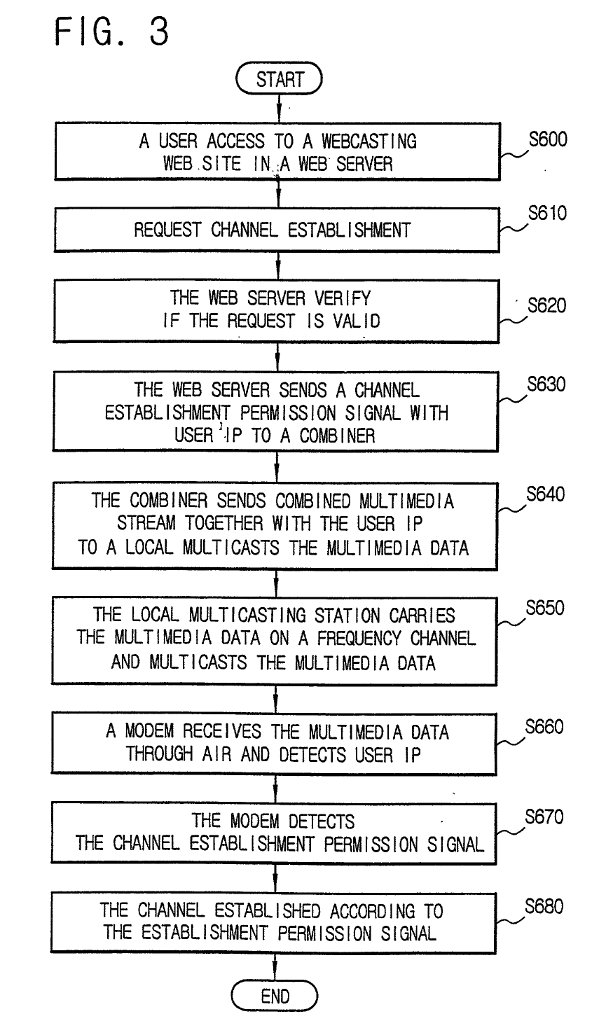

A webcasting method for multicasting various multimedia contents such as digital video through a plurality of channels in real time by employing a ground-wave according to the preferred embodiment of the present will be described with reference to FIG. 3 hereinafter.

The broadcasting stations 100 continuously transmit respective multimedia data to the combiner 200.

Firstly, a user terminal 800 accesses to the web page in the web server 300 over the public network 700 at step S600, and then request the web server 300 to establish a channel at step S610 by sending a channel establishment request packet to the web server 300.

If the web server 300 receives the channel establishment request packet, the web server 300 determines whether the request is valid or not by comparing a user IP in a packet header of the channel establishment request packet to a subscriber table stored therein at step S620. If the channel establishment request is valid, the web server 300 responsively produce a channel establishment permission packet by attaching the user IP and sends the channel establishment permission packet to the combiner 200 at step S630. In order to verify the subscriber, a user ID and password can be used.

When receiving the channel establishment permission packet, the combiner 200 sends the multimedia data packet to the local multicasting station 500 at step S640.

The local multicasting station 500 carries the multimedia data packet on one correspondingly assigned channel of the previously divided frequency channels and multicasts the multimedia data at step S650.

All the channels assigned respective broadcasting stations 100 are exposed to all the user terminals 800 having the antenna 600.

The antenna 600 receives all the data and sends the data to the modem 700 such that the modem filters the data packet having the corresponding user IP and send the packet to the user terminal 800 at step S660. Finally, the user terminal 800 detects the permission code in the data at step S670 and then complete channel establishment so as to download the data stream of the specific channel S680.

As described above, in the webcasting system and method for multicasting various multimedia contents, since the fixed frequency channels are assigned to respective broadcasting stations in a broadband frequency, a plurality of multimedia such as digital video can be serviced at the same time in real time.

Also, each channel has at least 1 Mbps of bandwidth such that high quality multimedia stream service can be provided in reliable speed.

Furthermore, at least one downward webcasting channel and at least data communication channel are fixedly assigned, there is no traffic burst, resulting in reliable high quality multimedia services.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A webcasting system for multicasting various multimedia contents through plurality of channels in real time by employing a ground-way technology comprises:
a plurality of broadcasting stations for providing multimedia services;
a combiner connected to the broadcasting stations for combining the multimedia services;
a web server 300 connected to the combiner and a public network for communicating with the combiner and receiving subscription for the multimedia services;
at least one local multicasting station connected to the combiner for receiving combined data stream from the combiner;
a plurality of user terminals connected to the web server via public network.

2. The webcasting system of claim 1 further comprises a modem installed in or connected to each user terminal for communicating with the local multicasting station.

3. The webcasting system of claim 1 further comprises a two-way antenna connected to the modem for receiving and transmitting signals.

4. The webcasting system of claim 2 wherein the modem is connected to the web server through a backup line for maintaining communication between the web server and the user terminal even when a wireless channel between the local multicasting station and the user terminal is broken.

5. The webcasting system of claim 1 wherein the combiner is a an intelligent hub.

6. The webcasting system of claim 5 wherein the combiner is an intelligent LAN switch.

7. The webcasting system of claim 5 wherein the combiner is a router.

8. The webcasting system of claim 1 wherein the local multicasting station modulates the data from the combiner by 64 QAM and take the data on a predetermined frequency.

9. The webcasting system of claim 8 wherein the frequency has a range of 2.535 to 2.655 Ghz.

10. The webcasting system of claim 9 wherein the frequency range is provided with a plurality of frequency channels.

11. The webcasting system of claim 10 wherein each frequency channel has 6 Mhz bandwidth.

12. The webcasting system of claim 11 wherein the 6 Mhz channel has 27 Mbps bandwidth by 64QAM.

13. The webcasting system of claim 12 wherein each frequency channel is provided with 27 1 Mbps sub-channels.

14. The webcasting system of claim 10 wherein at least one frequency channel is assigned for multimedia webcasting and at least one frequency channel for data communication.

15. The webcasting system of claim 2 wherein the modem comprises:
an antenna for receiving data signals from the local multicasting station and transmitting signal from the user terminal;
a splitter connected to the antenna for splitting the received data signals;
a filter connected to the splitter for filtering a controlling signal and data signal;
a demodulator connected to the filter for demodulating the controlling signal and data signal;
a decoder connected to the QAM demodulator for decoding the controlling and data signal;
a controller connected to the decoder for detecting user IP and channel establishment of release signal so as to establish or release webcasting;
an encoder connected to the controller 720 for encoding digital signal from the user terminal; and
a QAM modulator connected to the encoder for modulating encoded digital signal form the encoder and sending modulated signal to the filter.

16. The webcasting system of claim 15 wherein the modem is provided with a port for connecting to the web server via public network such that the channel connection is maintained even when a wireless connection is broken.

17. A webcasting method for multicasting various multimedia contents comprises the steps of:
(a) subscribing for multimedia services on a web site in a web server connected to a public network;
(b) registering a subscriber as a member by storing a subscriber IP and other subscriber's information;
(c) requesting channel establishment to the web server by the subscriber sending a channel establishment request signal;
(d) verifying the subscriber by looking up a table listing the subscriber IPs; and
(e) establishing a channel if the subscriber IP is valid.

18. A webcasting method of claim 17 further comprises a steps of:
(f) producing various multimedia data by a plurality of broadcasting stations; and
(g) combining the multimedia data from the broadcasting stations by a combiner.

19. A webcasting method of claim 17 further comprises the steps of:
(h) sending the subscriber IP and a channel establishment permission signal from the web server to the combiner;
(i) inserting the subscriber ID into a data field of the packet on the basis of the channel establishment permission signal.

20. A webcasting method of claim 17 further comprises the steps of;
(j) carrying the multimedia data on a predetermined frequency band.

21. A webcasting method of claim 20 where in the frequency band is 2.532 Ghz to 2.655 Ghz.

22. A webcasting method of claim 21 wherein the frequency band has a plurality of frequency channels.

23. A webcasting method of claim 22 wherein each frequency channel has a plurality of sub-channels.

24. A webcasting method of claim 22 wherein among the plurality of frequency channels, at least one channel is assigned for downward webcasting and at least one channel is assigned for other data communication such as video conference, internet access.

25. A webcasting method of claim 23 wherein each sub-channel has a bandwidth of 1 Mbps.

26. A webcasting method of claim 20 further comprises the step of propagating the multimedia data signal carried on the predetermined frequency band through air.

27. A webcasting method of claim 26 further comprises the steps of:
receiving the multimedia data signals from the local multicasting station;
splitting the multimedia data signals according to the frequency channels;
filtering a controlling and data signal from the multimedia data signal;
demodulating the controlling and data signals;
decoding the demodulated controlling and data signals;
detecting the subscriber IP and channel establishment or release signal; and
establishing or releasing channels according to the channel establishment or release signal.
